(19) United States
(12) Patent Application Publication
(10) Pub. No.: US 2004/0126297 A1
(43) Pub. Date: Jul. 1, 2004

(54) Integrated catalyst-heat exchanger and method of oxidizing carbon monoxide in a hydrogen reformer of a vehicle fuel cell system

(75) Inventors: Saemin Choi, Ann Arbor, MI (US); Sivaraj Chokkaram, Ann Arbor, MI (US); Craig Linne, Monroe, MI (US); Zhu Meng, Northville, MI (US); Homam Albaroudi, Ypsilanti, MI (US); Evangelos Papoulis, Northville, MI (US)

Correspondence Address: VISTEON, C/O BRINKS HOFER GILSON & LIONE, CHICAGO, IL, 60610, US

(73) Assignee: VISTEON GLOBAL TECHNOLOGIES, INC.

(21) Appl. No.: 10/330,782

(22) Filed: Dec. 27, 2002

(51) Int. Cl. B01D 53/62

(52) U.S. Cl. 423/247

(57) ABSTRACT

The present invention involves a system and method of oxidizing carbon monoxide in a preferential oxidizer for a hydrogen reformer of a fuel cell system for vehicular and stationary applications. The method includes providing a heat exchange system of the preferential oxidizer, wherein the heat exchange system has a single integrated oxidation reaction region in which an oxidation catalyst is disposed for oxidizing carbon monoxide to carbon dioxide. The method further includes introducing a hydrogen-rich reformate to the heat exchange system, wherein the hydrogen-rich reformate is at a predetermined temperature and has a first content of carbon monoxide. The method further includes injecting oxygen to the hydrogen-rich reformate, wherein the oxygen is at a predetermined stoichiometric oxygen/carbon monoxide ratio. The method further includes oxidizing at least a portion of the carbon monoxide to carbon dioxide with the oxidation catalyst when the hydrogen-rich reformate and oxygen contact the single integrated oxidation reaction region so that the hydrogen-rich reformate has a second content of carbon monoxide less than the first content at the predetermined temperature. The method further includes maintaining the hydrogen-rich reformate at the predetermined temperature when the carbon monoxide is oxidized in the single integrated reaction region of the heat exchange system.

### BACKGROUND OF THE INVENTION

The present invention relates to an integrated catalyst-heat exchanger for oxidizing carbon monoxide in a hydrogen reformer of a fuel cell system for stationary and vehicular applications.

Fuel cells generate electricity from chemical oxidation-reduction reactions and provide several advantages over other forms of power generation. For example, fuel cells provide cleaner vehicle emissions, quieter operation and have higher efficiency than many other power generation systems. For example, a fuel cell stack in a fuel cell system based on Proton Exchange Membrane (PEM) technology utilizes hydrogen and oxygen to convert chemical energy into electrical energy. Many fuel cells use hydrogen as fuel and oxygen as an oxidizing agent. Without a hydrogen supply infrastructure, a hydrogen reformer is used with the fuel cell system such that fuel sources, e.g., hydrocarbons (liquid or gas) or alcohols, may be reformed to hydrogen-rich reformate. The hydrogen-rich reformate is rich with hydrogen, wherein hydrogen is used at the fuel cell stack. As known in the art, oxygen and hydrogen permeate through the fuel cell stack having a gas impermeable membrane and an anode and a cathode disposed on either side of the membrane. The hydrogen ions are generated at the anode and then pass through the membrane to create an external electrical driving force.

A fuel reforming process within a fuel cell system may vary. For example, one process may include an autothermal reformer (ATR) which receives hydrocarbons typically stored in a tank of the vehicle, a water gas shift (WGS) reactor which receives hydrogen-rich reformate from the ATR reformer, and a preferential oxidation reactor (PROX) which receives hydrogen-rich reformate from the WGS reactor. Each of the units mentioned may include a plurality of stages for cooling the reformate and reducing carbon monoxide

Manufacturers have been challenged in increasing the efficiency of such units mentioned above. Particularly, the efficiency of the PROX reactor is desired to be improved. In many systems, a plurality of stages including heat exchangers and catalyst beds are required within the PROX reactor to maintain the reformate at a desired temperature range while oxidizing carbon monoxide to carbon dioxide prior to entering the fuel cell stack. Currently, without a plurality of stages, an uncontrollable rise in temperature in the PROX reactor would result from oxidizing carbon monoxide to carbon dioxide, due to the exothermic reaction of oxidizing carbon monoxide. A rise in temperature due to the exothermic reaction enhances undesired hydrogen-oxygen oxidation reactions, thereby diluting the hydrogen-rich reformate and reducing oxidation of carbon monoxide. Carbon monoxide is typically undesirable at the fuel cell stacks. It is known that even relatively small amounts of carbon monoxide, e.g. 1.0 volume percent, is detrimental to the performance of the electro-catalysts in the PEM fuel cell stack under typical operating conditions. A rise in carbon monoxide content in the reformate results in reduced performance of the PEM fuel cell system. Moreover, a rise in oxygen content enhances hydrogen reduction to water.

### BRIEF SUMMARY OF THE INVENTION

Thus, it is one aspect of the present invention to provide a method of oxidizing carbon monoxide in a preferential oxidizer of a PEM fuel cell system wherein the preferential oxidizer includes an integrated catalyst-heat exchanger. The present invention eliminates the need of a plurality of stages including a plurality of catalyst beds and heat exchangers for oxidizing carbon monoxide to carbon dioxide, while maintaining a predetermined temperature of the reformate. The preferential oxidizer includes a heat exchange system having a single integrated oxidation reaction region at which an oxidation catalyst is disposed for oxidizing carbon monoxide to carbon dioxide.

In one embodiment, a method of oxidizing carbon monoxide in the preferential oxidizer includes providing a heat exchange system of the preferential oxidizer. The heat exchange system has a single integrated oxidation reaction region in which an oxidation catalyst is disposed for oxidizing carbon monoxide to carbon dioxide. The method further comprises introducing a hydrogen-rich reformate to the heat exchange system. The hydrogen-rich reformate is at a predetermined temperature and has a first content of carbon monoxide.

The method further includes injecting oxygen to the hydrogen-rich reformate, wherein the oxygen is at a predetermined stoichiometric oxygen-carbon monoxide ratio. The method further includes oxidizing at least a portion of the carbon monoxide to carbon dioxide with the oxidation catalyst when the hydrogen-rich reformate and oxygen contact the single integrated oxidation reaction region so that the hydrogen-rich reformate has a second content of carbon monoxide less than the first content at the predetermined temperature. The method further includes maintaining the hydrogen-rich reformate at the predetermined temperature when the carbon monoxide is oxidized in the single integrated reaction region of the heat exchange system.

Other objects and advantages of the present invention will become apparent upon considering the following detailed description and appended claims, and upon reference to the accompanying drawings.

### BRIEF DESCRIPTION OF THE DRAWINGS

FIG. 1 is a side view of a preferential oxidation (PROX) reactor at which a method of oxidizing carbon monoxide is implemented in accordance with one embodiment of the present invention;

FIG. 2 is a cross-sectional side view of the PROX reactor depicting a heat exchanger system taken along lines 2-2 in accordance with one embodiment of the present invention;

FIG. 3 is a top cross-sectional view of the integrated catalyst-heat exchanger in FIG. 2 to which an oxidation catalyst is applied for oxidizing carbon monoxide to carbon dioxide taken along lines 3-3 in accordance with one embodiment of the present invention;

FIG. 4 is a side breakaway view of a single integrated oxidation reaction region of the integrated catalyst-heat exchanger taken from circle 4-4 in FIG. 1 in accordance with one embodiment of the present invention; and

FIG. 5 is a flow chart illustrating a method of oxidizing carbon monoxide in a preferential oxidizer for a hydrogen reformer of a fuel cell system in accordance with one embodiment of the present invention.

### DETAILED DESCRIPTION OF THE INVENTION

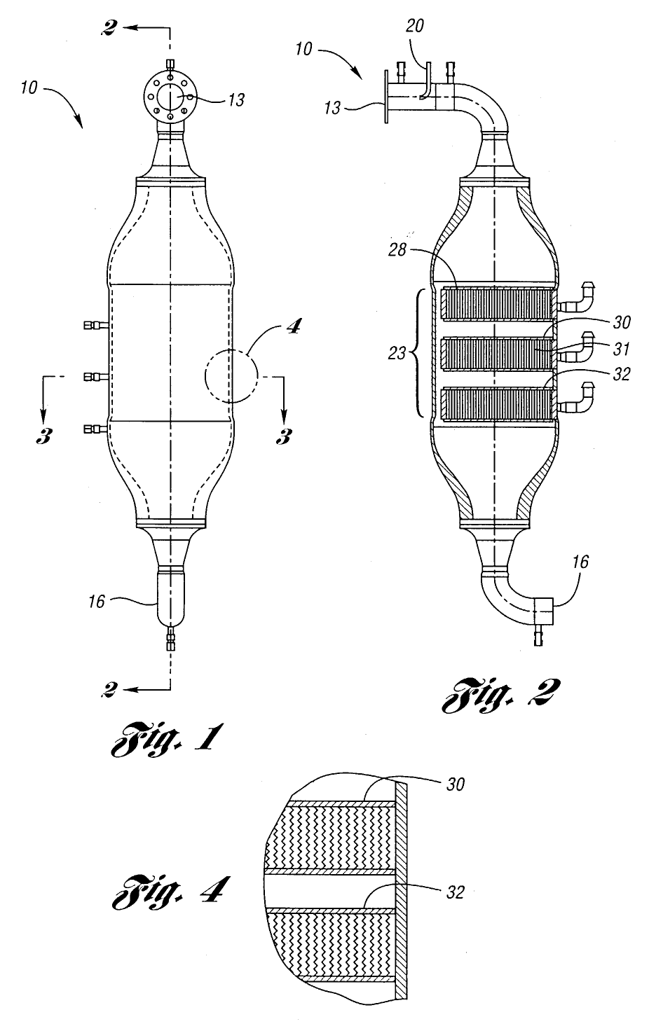

FIG. 1 illustrates a preferential oxidation (PROX) reactor 10 for oxidizing carbon monoxide in a hydrogen reformer process of a fuel cell system, e.g., a PEM fuel cell system. As shown, the PROX reactor 10 includes a reactor inlet 13 and a reactor outlet 16 through which hydrogen-rich reformate and oxygen pass. The hydrogen-rich reformate may be introduced from an upstream unit (not shown), e.g., a water gas shift (WGS) unit, and the oxygen may be injected through inlet nozzle 20 to contact and mix with the hydrogen-rich reformate.

The hydrogen-rich reformate is at a predetermined temperature and has a first content of carbon monoxide. In this embodiment, the predetermined temperature of the reformate is between about 200° C.-300° C. The first content of carbon monoxide of the reformate is about 1.0 percent of carbon monoxide. The oxygen is injected through the nozzle 20 at a volumetric flow rate such that a predetermined stoichiometric oxygen-carbon monoxide ratio is achieved within the reformate. In this embodiment, the oxygen is provided by air at ambient conditions and the stoichiometric oxygen-carbon monoxide ratio is between about 0.5:1 and 5.0:1. By injecting oxygen to the hydrogen-rich reformate, mixing of the oxygen with the hydrogen-rich reformate is achieved.

As shown in FIGS. 1 and 2, PROX reactor 10 includes a heat exchange system 23 having a plurality of heat exchangers for cooling and oxidizing the reformate. In this embodiment, the heat exchange system 23 includes a first heat exchanger 28, a second heat exchanger or an integrated catalyst-heat exchanger 30 having a single integrated oxidation reaction region 31, and a third heat exchanger 32. As will be described in greater detail below, the single integrated oxidation reaction region 31 includes an oxidation catalyst disposed thereon for oxidizing carbon monoxide to carbon dioxide. The oxidation catalyst may be any suitable catalyst including a noble metal-based catalyst such as platinum-based catalyst, palladium-based catalyst, or any other suitable catalyst.

In this embodiment, before the hydrogen-rich reformate contacts the oxygen at ambient conditions, the reformate is at about 200° C.-300° C. and is cooled to about 180° C.-280° C. before contacting the first heat exchanger 28. After contacting the first heat exchanger 28, the reformate and oxygen are cooled to a temperature of about 90° C.-150° C., and preferably about 100° C.-120° C. The first heat exchanger 28 may be any suitable heat exchanger known in the art for cooling hydrogen-rich reformate.

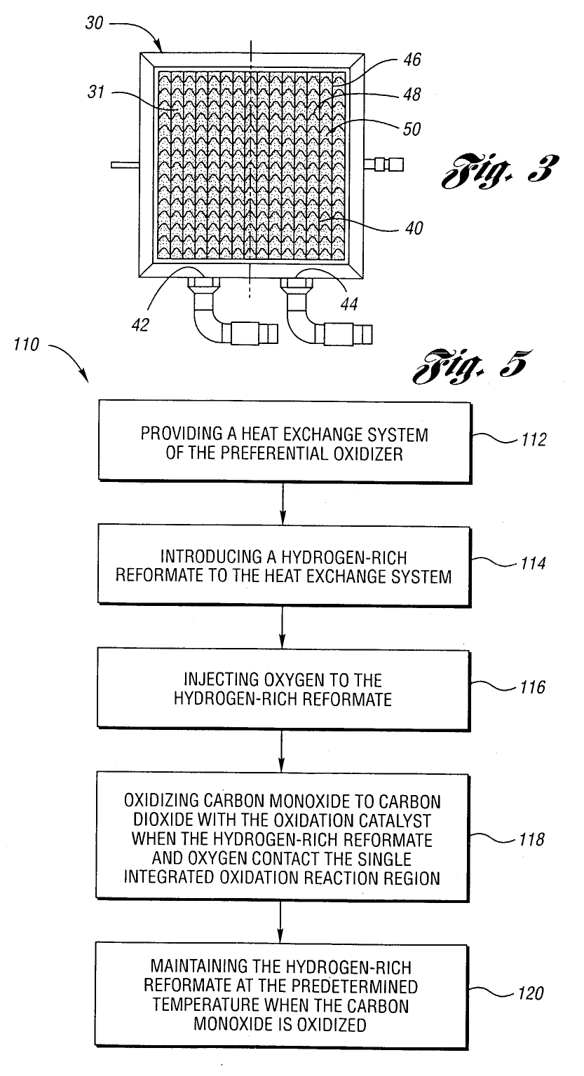

As shown in FIGS. 3 and 4, in this embodiment, the second heat exchanger 30 is an integrated catalyst-heat exchanger comprising a plurality of tubes 40 extending from an inlet manifold 42 to an outlet manifold 44 for coolant. As shown, the plurality of tubes has a plurality of external surfaces 46 for cooling. In this embodiment, the integrated catalyst-heat exchanger includes a plurality of fins 48 disposed along the external surfaces and having a plurality of contact areas 50 to which the oxygen and reformate contact for cooling. The contact areas 50 of the integrated catalyst-heat exchanger further includes an oxidation catalyst applied thereon to define a single integrated oxidation reaction region 31 for oxidation of carbon monoxide to carbon dioxide when hydrogen-rich reformate and oxygen contact the contact areas 50 and external surfaces 46 during normal operation.

As reformate and oxygen contact the oxidation catalyst at the reaction region 31 of the integrated catalyst-heat exchanger 30, at least a portion of the carbon monoxide is oxidized to carbon dioxide. After oxidation, the hydrogen-rich reformate has a second content of carbon monoxide less than the first content at the predetermined temperature. In this embodiment, the second content of carbon monoxide is about less than 10 parts per million of carbon monoxide. Moreover, upon contact with the integrated catalyst-heat exchanger, the reformate is cooled and maintained at the predetermined temperature, e.g., 100° C.-120° C., thereby avoiding a rise in temperature. In this embodiment, although carbon monoxide oxidation results in an exothermic reaction resulting in a rise in temperature, the reformate is cooled and maintained at about 100° C.-120° C. after contacting the integrated catalyst-heat exchanger 30. This eliminates the need for a plurality of heat exchanger stages and catalyst bed stages to maintain the reformate at between about 100° C.-120° C. The reformate then contacts the third heat exchanger 32 for further cooling. As noted above, before contacting the third heat exchanger 32, the reformate is at about 100° C.-120° C. and, upon contact with the third heat exchanger 32, is further cooled to less than about 80° C. The third heat exchanger 32 may be any suitable heat exchanger known in the art for cooling hydrogen-rich reformate.

It is to be noted that the first heat exchanger 28 and the third heat exchanger 32 are not required to be disposed within the PROX reactor 10 so long as a cooling unit or heat exchanger is disposed upstream exchanger 30 to cool the hydrogen-rich reformate to the predetermined temperature before contacting the integrated catalyst-heat exchanger and downstream of the exchanger 30 to further cool the reformate below 80° C. after contacting the reaction region 31. Thus, the temperature of reformate and oxygen may be maintained to about 100° C.-120° C. during oxidation of the carbon monoxide to carbon dioxide without requiring multiple stages of catalyst beds and heat exchangers for oxidation of carbon monoxide. The hydrogen-rich reformate is maintained at the predetermined temperature when the carbon monoxide is oxidized in the single integrated reaction region of the heat exchange system.

FIG. 5 illustrates a flow chart depicting a method 110 of oxidizing carbon monoxide in a preferential oxidation (PROX) reactor for a hydrogen reformer of a vehicle fuel cell system. As shown, method 110 includes providing in box 112 the heat exchanger system of the PROX reactor. As mentioned above, the heat exchange system has a single integrated oxidation reaction region at which an oxidation catalyst is disposed for oxidizing carbon monoxide to carbon dioxide. The method 110 further includes introducing in box 114 the hydrogen-rich reformate to the heat exchange system, wherein the hydrogen-rich reformate is at a predetermined temperature, e.g., 100° C.-120° C., and has a first content, e.g., 1 percent, of carbon monoxide. Method 110 further includes injecting in box 116 oxygen to the hydrogen-rich reformate. The oxygen is injected at a predetermined stoichiometric oxygen-carbon monoxide ratio, e.g., of between about 0.5:1 and 5.0:1.

Method 110 further includes oxidizing in box 118 at least a portion of the carbon monoxide to carbon dioxide with the oxidation catalyst when the hydrogen-rich reformate and oxygen contact the single integrated oxidation reaction region. The oxidation of carbon monoxide reduces the content of carbon monoxide within the hydrogen-rich reformate to a second content, e.g., about less than 10 parts per million, of carbon monoxide less than the first content at the predetermined temperature. Furthermore, method 110 includes maintaining in box 120 the hydrogen-rich reformate at the predetermined temperature when the carbon monoxide is oxidized in the single integrated reaction region of the heat exchange system.

The integrated catalyst-heat exchanger for the PROX reactor may be any suitable heat exchanger having an oxidation catalyst applied on to external surfaces and contact areas for oxidation of carbon monoxide to carbon dioxide and reformate cooling. In this embodiment, the catalyst-heat exchanger includes a plurality of tubes having an inlet manifold and extend to an outlet manifold for coolant to pass therethrough while reformate contacts the external surface. In this embodiment, the catalyst-heat exchanger further includes a plurality of fins having a plurality of contact areas to which an oxidation catalyst is applied. In use, the reformate contacts the contact area and the external surface of the integrated catalyst-heat exchanger for oxidation of carbon monoxide and cooling of the reformate which is maintained at the predetermined temperature as mentioned above without a plurality of cooling and catalyst stages.

The integrated catalyst-heat exchanger may be made by any suitable process. For example, a heat exchanger may be held in a fixture, and the oxidation catalyst may be applied on the contact areas and the external surface of the heat exchanger. This may be accomplished by spraying or applying the oxidation catalyst thereon at ambient conditions. Furthermore, the heat exchanger may be dried at elevated temperatures such as at about 90° F. to 900° F. to dry and adhere the oxidation catalyst applied on the heat exchanger. The resulting integrated catalyst-heat exchanger may be used in the PROX reactor as mentioned above, separately or in any other hydrogen reforming unit for a fuel cell system, e.g., a PEM fuel cell system.

The foregoing discussion discloses and describes the preferred embodiment of the invention. One skilled in the art will readily recognize from such discussion, and from the accompanying drawings and claims, that changes and modifications can be made to the invention without departing from the true spirit and fair scope of the invention as defined in the following claims. The invention has been described in an illustrative manner, and it is to be understood that the terminology which has been used is intended to be in the nature of words of description rather than of limitation.

1. A method of oxidizing carbon monoxide in a preferential oxidizer for a hydrogen reformer of a fuel cell system, the method comprising:
providing a heat exchange system of the preferential oxidizer, the heat exchange system having a single integrated oxidation reaction region in which an oxidation catalyst is disposed for oxidizing carbon monoxide to carbon dioxide;
introducing a hydrogen-rich reformate to the heat exchange system, the hydrogen-rich reformate being at a predetermined temperature and having a first content of carbon monoxide;
injecting oxygen to the hydrogen-rich reformate, the oxygen being at a predetermined stoichiometric oxygen/carbon monoxide ratio;
oxidizing the carbon monoxide to carbon dioxide with the oxidation catalyst when the hydrogen-rich reformate and oxygen contact the single integrated oxidation reaction region so that the hydrogen-rich reformate has a second content of carbon monoxide less than the first content at the predetermined temperature; and
maintaining the hydrogen-rich reformate at the predetermined temperature when the carbon monoxide is oxidized in the single integrated reaction region of the heat exchange system

2. The method of claim 1 wherein the heat exchange system includes an integrated catalyst-heat exchanger comprising:
at least one tube having an inlet and an outlet for coolant, the tube having an external surface;
at least one fin disposed along the external surface, fin having at least one contact area; and
an oxidation catalyst applied on the contact area of the fin for oxidation of carbon monoxide.

3. The method of claim 1 wherein the predetermined temperature of the reformate is between about 100° C.-120° C.

4. The method of claim 1 wherein the first content of carbon monoxide of the reformate is about 1.0 volume percent of carbon monoxide.

5. The method of claim 1 wherein the predetermined stoichiometric oxygen/carbon monoxide ratio is between about 0.5:1 and 5.0:1.

6. The method of claim 1 wherein the oxygen is at ambient conditions.

7. The method of claim 1 wherein the step of injecting oxygen to the hydrogen-rich reformate includes mixing the oxygen with the hydrogen-rich reformate.

8. The method of claim 1 further comprising mixing the oxygen with the hydrogen-rich reformate, after injecting the oxygen.

9. The method of claim 1 wherein the step of oxidizing the carbon monoxide includes cooling the hydrogen-rich reformate when the hydrogen-rich reformate and oxygen contact the single integrated oxidation reaction region.

10. The method of claim 1 further comprising cooling the hydrogen-rich reformate when the hydrogen-rich reformate and oxygen contact the single integrated oxidation reaction region.

11. The method of claim 1 wherein the second content of carbon monoxide is about less than 10 parts per million carbon monoxide.

12. The method of claim 1 wherein the heat exchange system includes a first heat exchanger for cooling the hydrogen-rich reformate and integrated catalyst-heat exchanger for cooling the reformate and oxidizing carbon monoxide after the first heat exchanger and a second heat exchanger for cooling the reformate after the integrated catalyst-heat exchanger.

13. The method of claim 12 wherein introducing the reformate includes:
introducing the reformate to the first heat exchanger at a first temperature;
cooling the reformate to the predetermined temperature; and
introducing the reformate from the first heat exchanger to the integrated catalyst-heat exchanger at the predetermined temperature and having the first content of carbon monoxide.

14. The method of claim 13 further comprising introducing the reformate at the predetermined temperature from the integrated catalyst-heat exchanger to the second heat exchanger to cool the reformate to a second temperature.

15. The method of claim 14 wherein the second temperature is about 80° C.

16. The method of claim 13 wherein the first temperature is between about 200° C.-300° C.

17. The method of claim 13 wherein the predetermined temperature is between about 100° C.-120° C.

18. A method of oxidizing carbon monoxide in a preferential oxidizer for a hydrogen reformer of a fuel cell system, the method comprising:
providing a heat exchanger system having a single integrated oxidation reaction region in which an oxidation catalyst is disposed for oxidizing carbon monoxide to carbon dioxide;
introducing a hydrogen-rich reformate to the heat exchanger system for cooling, the hydrogen-rich reformate being at a predetermined temperature and having about 1% by volume of carbon monoxide;
injecting oxygen to the hydrogen-rich reformate, the oxygen being at a predetermined stoichiometric oxygen-carbon monoxide ratio;
oxidizing the carbon monoxide to carbon dioxide to reduce the carbon monoxide content of the hydrogen-rich reformate to about less than ten parts per million carbon monoxide at the predetermined temperature; and
maintaining the hydrogen-rich reformate at the predetermined temperature as the hydrogen-rich reformate passes the integrated oxidation reaction region.

19. An integrated catalyst-heat exchanger for a hydrogen reforming process of a fuel cell system, the catalyst-heat exchanger comprising:
at least one tube having an inlet and an outlet for coolant, the tube having an external surface;
at least one fin disposed on the external surface and extending therealong, the fin having a contact area; and
an oxidation catalyst applied on the contact area of the fin for oxidation of carbon monoxide.

20. A method of making an integrated catalyst-heat exchanger for a hydrogen reforming process of a vehicle fuel cell system, the method comprising:
providing a heat exchanger for the hydrogen reforming process, the heat exchanger including at least one tube having an inlet and an outlet for coolant, the tube having an external surface, the heat exchanger further including at least one fin disposed on the external surface and extending therealong, the fin having a contact area;
holding the heat exchanger in a fixture;
applying an oxidation catalyst on the contact area of the fins for carbon monoxide oxidation during the hydrogen reforming process; and
drying the oxidation catalyst applied on the contact area of the fins.
